(19) United States
(12) Patent Application Publication
(10) Pub. No.: US 2020/0001657 A1
(43) Pub. Date: Jan. 2, 2020

(54) PNEUMATIC TIRE

(71) Applicant: TOYO TIRE CORPORATION, Itami-shi (JP)

(72) Inventor: Keisuke Matsubara, Itami-shi (JP)

(73) Assignee: TOYO TIRE CORPORATION, Itami-shi (JP)

(21) Appl. No.: 16/453,099

(22) Filed: Jun. 26, 2019

(30) Foreign Application Priority Data
Jun. 29, 2018 (JP) 2018-125055

(51) Int. Cl. B60C 11/12

(52) U.S. Cl. CPC B60C 11/1236; B60C 11/1204; B60C 2011/1213; B60C 11/1259; B60C 11/124

(57) ABSTRACT

A pneumatic tire includes a sipe line that is a line constituted of continuation of the sipe. The sipe line extends from one grounding end toward the other grounding end of the tread portion and has an amplitude in both a tire circumferential direction and a tire width direction.

### CROSS-REFERENCE TO RELATED APPLICATIONS

This application claims priority of Japanese Patent Application No.: 2018-125055 filed on Jun. 29, 2018, the content of which is incorporated herein by reference.

### BACKGROUND OF THE INVENTION

### Technical Field

The present invention relates to a pneumatic tire.

### Related Art

Japanese Patent Application Laid-Open No. 2016-101886 discloses an all-weather pneumatic tire (all-season tire) suitable for traveling on a dry road surface but also capable of traveling on a snowy road surface. In a tread portion of the all-season tire, a sipe is formed in the tread portion as in a snow tire. Since an all-season tire is mainly intended for traveling on the dry road surface, the total number of sipes included in the all-season tire is generally smaller than that of the snow tire.

### SUMMARY

Conventional all-season tires, including those disclosed in Japanese Patent Application Laid-Open No. 2016-101886, still have room for improvement in terms of improving traveling performance on the snowy road surface while ensuring traveling performance on the dry road surface.

An object of the present invention is to provide a pneumatic tire that has an improved traveling performance on the snowy road surface while ensuring traveling performance on the dry road surface.

One aspect of the present invention provides a pneumatic tire including: a plurality of main grooves formed in a tread portion so as to extend in a tire circumferential direction; a plurality of land portions defined by at least the main grooves; and a plurality of sipes respectively formed on the land portions, wherein a sipe line that is a line constituted of continuation of each sipe extends from one grounding end toward another grounding end of the tread portion and has an amplitude in both a tire circumferential direction and a tire width direction.

The sipe line crossing the tread portion in the tire width direction has an amplitude in both the tire circumferential direction and the tire width direction. Therefore, the sipe density can be increased without increasing the number of sipes. Since the sipe line has an amplitude in the tire circumferential direction, the edge component extending in or near the tire circumferential direction can be increased without increasing the number of sipes, and hence anti-sideslip performance particularly on the snowy road surface is improved. Furthermore, since the sipe line has an amplitude in the tire width direction, the edge component extending in or near the tire width direction can be increased without increasing the number of sipes, and hence traction performance particularly on the snowy road surface is improved. In this manner, it is possible to improve anti-sideslip performance and traction performance on the snowy road surface, that is, traveling performance on the snowy road surface, while ensuring traveling performance on the dry road surface by not increasing the number of sipes.

Specifically, the sipe line includes a first circumferential protrusion portion that projects in one direction of the tire circumferential direction, a second circumferential protrusion portion that projects in a direction opposite to the direction of the tire circumferential direction, a first widthwise protrusion portion that projects in one direction of the tire width direction, and a second widthwise protrusion portion that projects in a direction opposite to the direction of the tire width direction.

More specifically, the first widthwise protrusion portion and the second widthwise protrusion portion are positioned between the first circumferential protrusion portion and the second circumferential protrusion portion.

According to this constitution, it is possible to suppress the positions of both end portions of the sipe line in the tire circumferential direction from excessively separating, that is, the overall sipe line from being largely inclined with respect to the tire width direction. As a result, some sipes that constitute the sipe line allow a sufficient amount of edge component extending in the tire width direction to be ensured, resulting in a better traction performance on the snowy road surface in particular.

The pneumatic tire further includes: a plurality of lateral grooves formed on the tread portion so as to extend in a direction intersecting with the tire circumferential direction, wherein the main groove includes a pair of center main grooves arranged adjacent to each other across a center line of the tread portion in a tire width direction, and both the first widthwise protrusion portion and the second widthwise protrusion portion of the sipe line may be constituted by one center sipe formed in a center block defined by the center main grooves and the lateral grooves.

The center sipe that constitutes the first and second widthwise protrusion portions of the sipe line have a meandering or amplitude in the tire width direction, and has a generally S shape. Therefore, the ground contact pressure at the center block is dispersed without being concentrated at one position, and hence the braking performance on the dry road surface can be improved. The two portions of the center block divided by the center sipe support each other at the time of braking, thereby suppressing collapse. As a result, braking performance and uneven wear-resistant performance can be improved.

The main groove includes a pair of shoulder main grooves respectively arranged adjacent to an outer side of the tire width direction with respect to the center main groove, the first circumferential protrusion portion may include a first mediate sipe formed in a first mediate block defined by one of the center main grooves, one of the shoulder main grooves that is positioned on the outer side of the tire width direction with respect to the one of the center main grooves, and the lateral grooves; and a second circumferential protrusion portion may include a first mediate sipe formed in a second mediate block defined by the other of the center main grooves, one of the shoulder main grooves that is positioned on the outer side of the tire width direction with respect to the other of the center main grooves, and the lateral grooves.

The first and second mediate sipes that constitute the first and second circumferential protrusion portions of the sipe line have a bent shape. According to this constitution, it is possible to avoid matching between the first and second mediate sipes with the grounding shape, and it is possible to reduce impact noise when traveling on the dry road surface in particular.

The end portion on the one center main groove side of the first mediate sipe may terminate in the first mediate block, and the end portion on the other center main groove side of the second mediate sipe may terminate in the second mediate block.

The first and second mediate sipes are not in communication with the center main groove. Therefore, it is possible to ensure the rigidity of the first and second mediate blocks, and possible to suppress the collapse of these blocks. As a result, braking performance and wear-resistant performance can be improved.

The pneumatic tire according to the present invention can realize traveling performance on the snowy road surface while ensuring traveling performance on the dry road surface.

### BRIEF DESCRIPTION OF THE DRAWINGS

The foregoing and the other features of the present invention will become apparent from the following description and drawings of an illustrative embodiment of the invention in which:

FIG. 1 is a development view of a tread pattern of a pneumatic tire according to an embodiment of the present invention;

FIG. 2 is a partial enlarged view of FIG. 1;

FIG. 3 is a development view of a tread pattern for explaining a sipe line;

FIG. 4A is a schematic partial enlarged development view of a tread pattern for explaining a condition in which a pair of sipes facing each other across a main groove constitute a sipe line;

FIG. 4B is a schematic partial enlarged development view of a tread pattern for explaining a condition in which a pair of sipes facing each other across a main groove constitute a sipe line;

FIG. 4C is a schematic partial enlarged development view of a tread pattern for explaining a condition in which a pair of sipes formed in a same land portion constitute a sipe line;

FIG. 4D is a schematic partial enlarged development view of a tread pattern for explaining a condition in which a pair of sipes formed in a same land portion constitute a sipe line;

FIG. 5 is an enlarged view of a center block of FIG. 1;

FIG. 6 is a view similar to FIG. 5 of an alternative of the center block;

FIG. 7 is an enlarged view of a mediate block of FIG. 1;

FIG. 8 is an enlarged view of a shoulder block of FIG. 1;

FIG. 9 is a schematic perspective view of a part of the shoulder block;

FIG. 10 is a view similar to FIG. 8 of a first alternative of the shoulder block;

FIG. 11 is a view similar to FIG. 8 of a second alternative of the shoulder block; and

FIG. 12 is a view similar to FIG. 8 of a third alternative of the shoulder block.

### DETAILED DESCRIPTION OF EMBODIMENTS

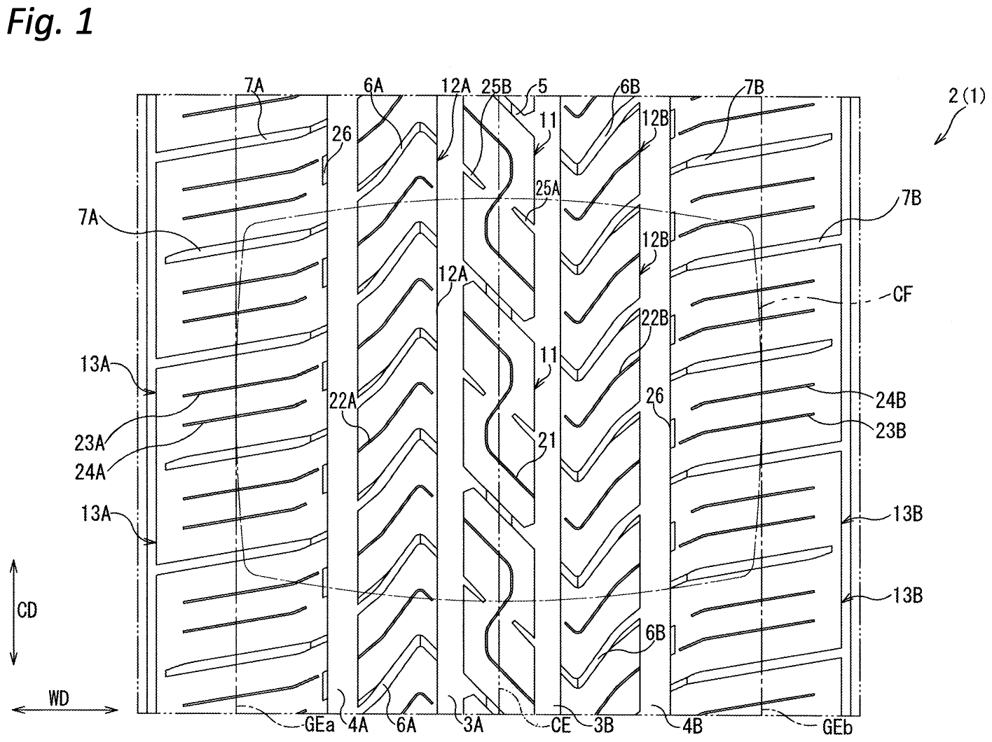

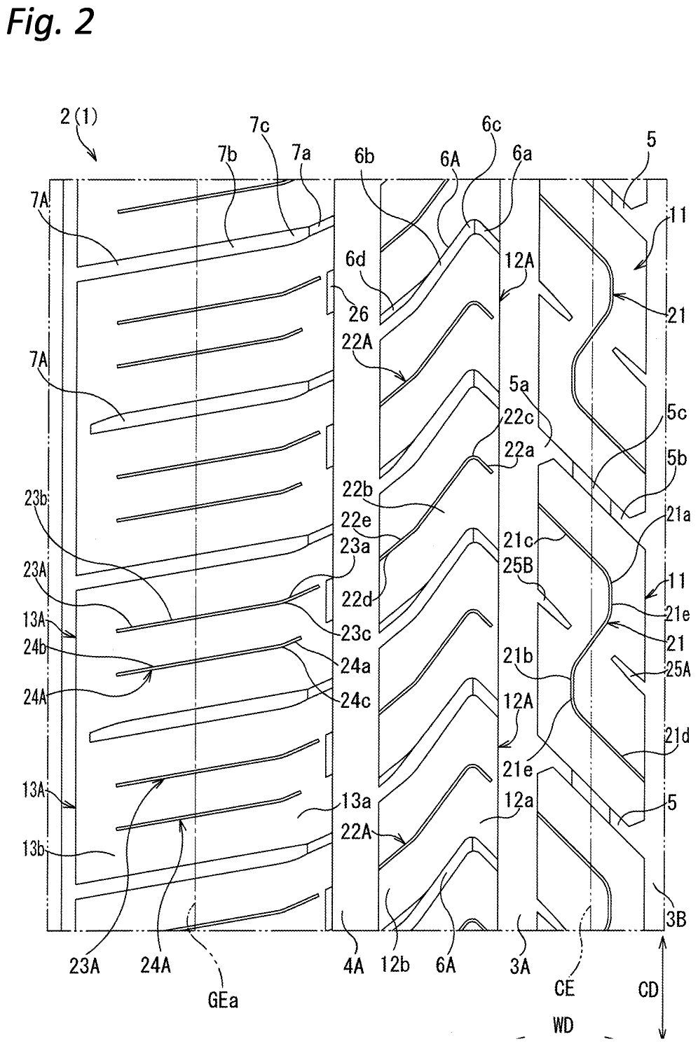

An embodiment of the present invention will be described with reference to the accompanying drawings. In the following description, FIG. 1 and FIG. 2 will be mainly referred to. For the other drawings, the drawings to be referred to are mentioned in the individual descriptions.

In the present description, the term “groove” means a notch having a certain width of, for example, about 2.5 mm or more, and the term “sipe” means a notch thinner than “groove” and having a width of, for example, 0.8 mm or more and 1.5 mm or less.

A pneumatic tire 1 (hereinafter simply referred to as a tire) according to the embodiment of the present invention is an all-weather, all-season tire that is suitable for traveling on a dry road surface but can also travel on a snowy road surface. In the figure, a reference symbol CD indicates a tire circumferential direction, and a reference symbol WD indicates a tire width direction. In the figure, a reference symbol CE indicates a center line in the tire width direction of a tread portion of the tire 1. Reference symbols GEa and GEb indicate grounding ends of a tread portion 2. A reference symbol CF indicates a grounding shape. The grounding ends GEa and GEb and the grounding shape CF are under the condition of 220 kPa/490 kgf.

The tread portion 2 is formed with four main grooves 3A, 3B, 4A, and 4B each extending in the tire circumferential direction. In the present embodiment, each of the main grooves 3A, 3B, 4A, and 4B is a linear groove having a certain groove width. The main grooves 3A, 3B, 4A, and 4B may have distribution in the groove width in the tire circumferential direction, or may be meandering or zigzag grooves.

The center main grooves 3A and 3B are arranged adjacent to each other across the center line CE. The shoulder main grooves 4A and 4B are arranged on the grounding end GEa and GEb sides. The shoulder main groove 4A is arranged on an outer side in the tire width direction with respect to the center main groove 3A, that is, adjacent to the grounding end GEa side. The shoulder main groove 4B is arranged on an outer side in the tire width direction with respect to the center main groove 3B, that is, adjacent to the grounding end GEb side.

The tread portion 2 is provided with five types of lateral grooves (lag grooves) 5, 6A, 6B, 7A, and 7B each extending generally in the tire width direction.

A plurality of the center lateral grooves 5 are provided at regular intervals in the tire circumferential direction. Both end portions of each of the center lateral grooves 5 are in communication with the center main grooves 3A and 3B. Each of the center lateral grooves 5 is linear as a whole, and is inclined with respect to the tire width direction so as to be downward-sloping in the figure. Each of the center lateral grooves 5 includes a first portion 5a communicating with the center main groove 3A, a second portion 5b communicating with the center main groove 3B, and a third portion 5c between the first portion and the second portion. The groove depth of the third portion 5c is shallower than the first and second portions 5a and 5b.

A plurality of the mediate lateral grooves 6A are provided at regular intervals in the tire circumferential direction. Each of the mediate lateral grooves 6A includes a first portion 6a communicating with the center main groove 3A and a second portion 6b communicating with the shoulder main groove 4A. The first portion 6a is inclined with respect to the tire width direction so as to be downward-sloping in the figure. The second portion 6b is inclined with respect to the tire width direction so as to be upward-sloping in the figure. That is, each of the mediate lateral grooves 6A has a bent shape bent at a bent portion 6c. The first portion 6a is sufficiently shorter in length than the second portion 6b. The first portion 6a is shallower in groove depth than the second portion 6b. A tapered portion 6d is provided on a groove wall at a connecting portion of the second portion 6b with the shoulder main groove 4A.

A plurality of the shoulder lateral grooves 7A are provided at regular intervals in the tire circumferential direction. Each of the shoulder lateral grooves 7A includes a first portion 7a communicating with the shoulder main groove 4A and a second portion 7b extending outward in the tire width direction beyond the grounding end GEa. The first and second portions 7a and 7b are both inclined with respect to the tire width direction so as to be upward-sloping in the figure. That is, each of the shoulder lateral grooves 7A has a bent shape slightly bent at a bent portion 7c. The inclination angle of the first portion 7a with respect to the tire width direction is larger than that of the second portion 7b. The first portion 7a is shallower in groove depth than the second portion 7b.

One center block 11 is defined by the center main grooves 3A and 3B and the two center lateral grooves 5 adjacent in the tire circumferential direction. A plurality of the center blocks 11 are aligned in the tire circumferential direction. Each of the center blocks has a parallelogram shape that is elongated in the tire circumferential direction as viewed in a tire radial direction.

One mediate block 12A is defined by the center main groove 3A, the shoulder main groove 4A, and the two mediate lateral grooves 6A adjacent in the tire circumferential direction. A plurality of the mediate blocks 12A are aligned in the tire circumferential direction. As described above, since the mediate lateral groove 6A has a bent shape, the individual mediate blocks 12A also have a bent shape as viewed in the tire radial direction. That is, each of the mediate blocks 12A has, on the center main groove 3A side, a first portion 12a that is inclined with respect to the tire width direction so as to be downward-sloping in the figure and is relatively short in length. Each of the mediate blocks 12A has, on the shoulder main groove 4A side, a second portion 12b that is inclined with respect to the tire width direction so as to be upward-sloping in the figure and is relatively long in length. Each of the mediate blocks 12A has a shape elongated in the tire width direction overall.

One shoulder block 13A is defined by the shoulder main groove 4A and the two shoulder lateral grooves 7A adjacent in the tire circumferential direction. A plurality of the shoulder blocks 13A are aligned in the tire circumferential direction. As described above, since the shoulder lateral grooves 7A have a slightly bent shape, each of the shoulder blocks 13A also has a first portion 13a that is relatively steep upward-sloping and is short in length and a second portion 13b that is relatively gentle upward-sloping and is long in length, as viewed in the tire radial direction. Each of the shoulder blocks 13A has a shape elongated in the tire width direction overall. The second portion 13b of the shoulder block 13A extends outward in the tire width direction beyond the grounding line GEa.

The mediate block 12A and the shoulder block 13A are provided at the identical pitch in the tire circumferential direction. On the other hand, the center block 11 is provided in the tire circumferential direction at a pitch twice the pitch of the mediate block 12A and the shoulder block 13A. That is, the one center block 11 is provided for the two mediate blocks 12A and the two shoulder blocks 13A. Therefore, as described above, the mediate block 12A and the shoulder block 13A have a shape elongated in the tire width direction, whereas the center block 11 has a shape elongated in the tire circumferential direction.

The pattern of the tread portion 2 of the present embodiment has a symmetry with respect to the center line CE. That is, the shape and structure of the mediate lateral groove 6B, the shoulder lateral groove 7B, the mediate block 12B, and the shoulder block 13B on the right side (grounding end GEb side) with respect to the center line CE in the figure are identical to those of the mediate lateral groove 6A, the shoulder lateral groove 7A, the mediate block 12A, and the shoulder block 13A, except being reversed upside down in the figure. In the figure, the elements included in the mediate lateral groove 6B and the like are given similar or identical reference symbols as the elements included in the mediate lateral groove 6A and the like. In the following description, unless otherwise necessary, the mediate lateral groove 6A, the shoulder lateral groove 7A, the mediate block 12A, and the shoulder block 13A on the left side (grounding end GEa side) with respect to the center line CE in the figure will be described.

One center sipe 21 is formed in each of the center blocks 11. The center sipe 21 extends from one side portion to the other side portion of the center block 11 in the tire width direction and crosses the center block 11 in the tire width direction. The center sipe 21 has a reverse S-shape extending in the tire circumferential direction as a whole, and is provided, in a continuous manner, with a first widthwise protrusion portion 21a projecting to the right side (grounding end GEb side) in the figure, and a second widthwise protrusion portion 21b projecting in the opposite direction to the first widthwise protrusion portion 21a, i.e., the left side (grounding end GEa side) in the figure. In other words, the center sipe 21 has an amplitude in the tire width direction. The other structure of the center block 11 will be described later.

One mediate sipe 22A is formed in each of the mediate blocks 12A. The mediate sipe 22A includes a first portion 22a, a second portion 22b, and a third portion 22d, each of which is linear. The first portion 22a includes an end portion terminating in the mediate block 12A, and is inclined with respect to the tire width direction so as to be downward-sloping in the figure. The end portion of the first portion 22a is positioned near the center main groove 3A. The second portion 22b is connected to the first portion 22a via a bent portion 22c, and is inclined with respect to the tire width direction so as to be upward-sloping in the figure. The third portion 22d is connected to the second portion 22b via a bent portion 22e, and is inclined with respect to the tire width direction at a gentler angle than the second portion 22b so as to be upward-sloping in the figure. The end portion of the third portion 22d opposite to the bent portion 22e is in communication with the shoulder main groove 4A. The other structure of the mediate block 12A will be described later.

The mediate sipe 12A overall has a bent shape projecting upward in the tire circumferential direction in the figure. On the other hand, the mediate sipe 22B formed in the mediate block 12B has a bent shape projecting in the opposite direction to the mediate sipe 12A, i.e., downward in the tire circumferential direction in the figure.

Two shoulder sipes 23A and 24A are formed in each of the shoulder blocks 13A.

The shoulder sipe 23A overall extends from the grounding end GEa toward the shoulder main groove 4A. The shoulder sipe 23A includes a first portion 23a and a second portion 23b. The first portion 23a is generally straight, includes an end portion terminating in the shoulder sipe 23A, and is inclined with respect to the tire width direction so as to be upward-sloping in the figure. The end portion of the first portion 23a is positioned near the shoulder main groove 4A. The second portion 23b is generally straight, is connected to the first portion 23a via a bent portion 23c, and is inclined with respect to the tire width direction at a gentler angle than the first portion 23a so as to be upward-sloping in the figure. The second portion 23b extends outward in the tire width direction beyond the grounding end GEa.

The shoulder sipe 24A overall extends from the grounding end GEa toward the shoulder main groove 4A. The shoulder sipe 24A includes a first portion 24a and a second portion 24b. The first portion 24a is generally straight, includes an end portion terminating in the shoulder block 13A, and is inclined with respect to the tire width direction so as to be upward-sloping in the figure. The end portion of the first portion 24a is positioned near the shoulder main groove 4A. The second portion 24b is generally straight, is connected to the first portion 24a via a bent portion 24c, and is inclined with respect to the tire width direction at a gentler angle than the first portion 24a so as to be upward-sloping in the figure. The second portion 24b extends outward in the tire width direction beyond the grounding end GEa.

The other structure of the shoulder block 13A will be described later.

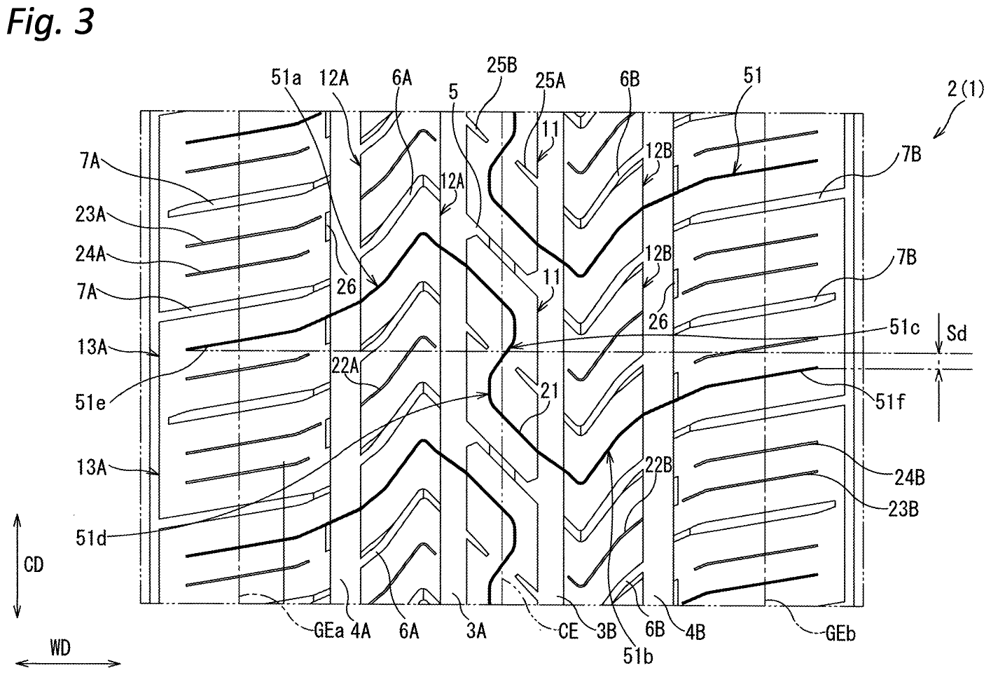

As conceptually shown by a reference symbol 51 in FIG. 3, the center sipe 21, the mediate sipes 22A and 22B, and the shoulder sipes 23A and 23B constitute a sipe line that is a line constituted by a continuous sipe. A sipe line 51 is not an arbitrary connection of two sipes when the end portions simply face in the tire width direction but a line obtained on an assumption that these two sipes are continuous only when a specific condition is satisfied. The conditions under which the two sipes with the end portions facing in the tire width direction are continuous are defined separately into a case where their end portions face each other across the main groove and a case where their end portions face in the same land portion (block or rib).

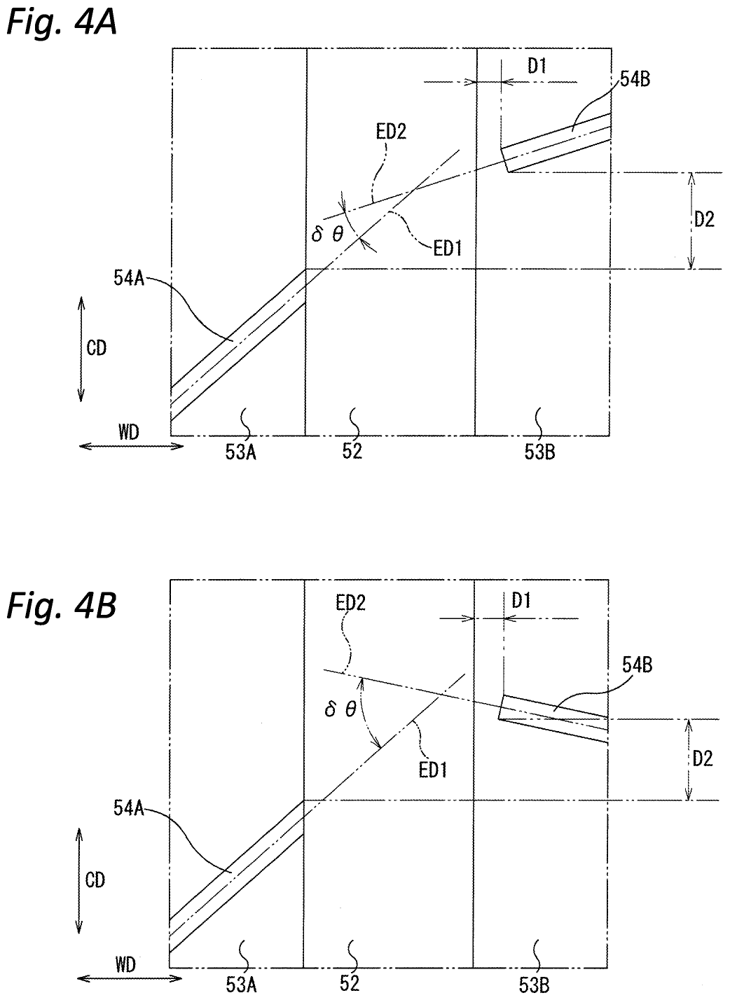

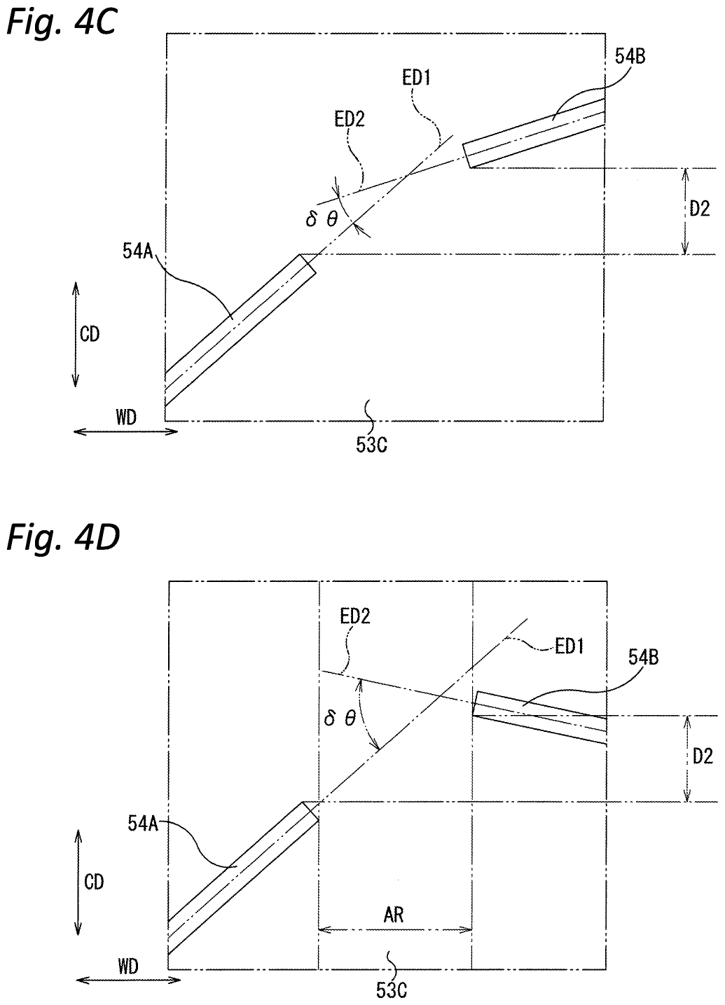

With reference to FIG. 4A and FIG. 4B, a condition under which two sipes can be assumed as continuous when the end portions of two sipes face each other across the main groove will be described. In these figures, two land portions 53A and 53B are arranged on both sides of a main groove 52, and sipes 54A and 54B are provided on the land portions 53A and 53B, respectively. In these examples, the end portion of the sipe 54A is in communication with the main groove 52, but the end portion of the sipe 54B terminates in the land portion 53B and is not in communication with the main groove 52.

The sipes 54A and 54B are assumed as continuous if both of conditions 1 and 2 are satisfied and any of conditions 3 and 4 is satisfied.

The condition 1 is that a shortest distance D1 in the tire width direction from the end portion of the sipe 54B terminating in the land portion 53B to the main groove 52 is 1.5 mm or less.

The condition 2 is that a shortest distance D2 in the tire circumferential direction of the end portions of the sipes 54A and 54B is 10 mm or less.

The condition 3 is that an angle (acute angle) 60 formed by lines ED1 and ED2 indicating the directions in which the sipes 54A and 54B extend is 80 degrees or less.

The condition 4 is that the lines ED1 and ED2 indicating the directions in which the sipes 54A and 54B extend intersect in the main groove 52.

In the case of FIG. 4A, the sipes 54A and 54B are assumed as continuous because both of the conditions 1 and 2 are satisfied and both of the conditions 3 and 4 are satisfied. On the other hand, in the case of FIG. 4B, the sipes 54A and 54B are assumed as continuous because both of the conditions 1 and 2 are satisfied and the condition 3 is not satisfied but the condition 4 is satisfied.

The shoulder sipe 23A and the mediate sipe 22A are assumed as continuous because they satisfy all the conditions 1 to 4 for the shoulder main groove 4A. The mediate sipe 22A (one with the end portion of the first portion 22a is positioned near the upper end of the center block 11 in the figure) and the center sipe 21 are assumed as continuous because they satisfy the conditions 1 to 3 for the center main groove 3A. The center sipe 21 and the mediate sipe 22B (one with the end portion of the first portion 22a is positioned near the lower end of the center block 11 in the figure) are assumed as continuous because they satisfy the conditions 1 to 3 for the center main groove 3B. Furthermore, the mediate sipe 22B and the shoulder sipe 23B are assumed as continuous because they satisfy the conditions 1 to 4 for the shoulder main groove 4B. Accordingly, from the left side (grounding end GEa side) toward the right side (grounding end GEb side) in the figure, the shoulder sipe 23A, the mediate sipe 22A, the center sipe 21, the mediate sipe 22B, and the shoulder sipe 23B are continuous successively and these sipes constitute the sipe line 51.

With reference to FIG. 4C and FIG. 4D, a condition under which two sipes can be assumed as continuous when the end portions of two sipes face each other in the same land portion will be described. In these figures, the sipes 54A and 54B in the same land portion 53C are provided.

The sipes 54A and 54B are assumed as continuous if both of conditions 1′ and 2′ are satisfied and condition 3′ is satisfied.

The condition 1′ is that the shortest distance D2 in the tire circumferential direction of the end portions of the sipes 54A and 54B is 10 mm or less.

The condition 2′ is that an angle (acute angle) 60 formed by the lines ED1 and ED2 indicating the directions in which the sipes 54A and 54B extend is 80 degrees or less.

The condition 3′ is that the lines ED1 and ED2 indicating the directions in which the sipes 54A and 54B extend intersect in a tire width direction area AR between the end portions of the sipes 54A and 54B.

With reference to FIG. 3, the sipe line 51 in the present embodiment has an amplitude in both the tire circumferential direction and the tire width direction. Hereinafter, this point will be described.

The sipe line 51 includes a first circumferential protrusion portion 51a that projects upward in the tire circumferential direction in the figure and a second circumferential protrusion portion 51b that projects in an opposite direction to the first circumferential protrusion portion 51a in the tire circumferential direction, that is, downward in the figure, and the first and second circumferential protrusions constitute an amplitude of the sipe line 51 in the tire circumferential direction. The first circumferential protrusion portion 51a includes the bent-shaped mediate sipe 22A formed on the mediate block 12A. The second circumferential protrusion portion 51b includes the bent-shaped mediate sipe 22B formed on the mediate block 12B.

The sipe line 51 includes, between the first circumferential protrusion portion 51a and the second circumferential protrusion portion 51b, a first widthwise protrusion portion 51c that projects rightward in the tire circumferential direction in the figure, and a second widthwise protrusion portion 51d that projects in an opposite direction to the first widthwise protrusion portion 51c in the tire circumferential direction, that is, leftward in the figure. The first widthwise protrusion portion 51c and the second widthwise protrusion portion 51d are provided continuously. The first widthwise protrusion portion 51c and the second widthwise protrusion portion 51d are constituted by the first widthwise protrusion portion 21a and the second widthwise protrusion portion 21b of the center sipe 21, respectively.

The sipe line 51 crosses the tread portion 2 in the tire width direction, and has an amplitude in both the tire circumferential direction and the tire width direction. Therefore, the sipe density can be increased without increasing the number of sipes. Since the sipe line 51 has an amplitude in the tire circumferential direction, the edge component extending in or near the tire circumferential direction can be increased without increasing the number of sipes, and hence anti-sideslip performance particularly on the snowy road surface is improved. Furthermore, since the sipe line 51 has an amplitude in the tire width direction, the edge component extending in or near the tire width direction can be increased without increasing the number of sipes, and hence traction performance particularly on the snowy road surface is improved. In this manner, it is possible to improve anti-sideslip performance and traction performance on the snowy road surface, that is, traveling performance on the snowy road surface, while ensuring traveling performance on the dry road surface by not increasing the number of sipes.

The first and second widthwise protrusion portions 51c and 51d are also provided continuously between the first circumferential protrusion portion 51a and the second circumferential protrusion portion 51b. Therefore, as shown by a reference symbol Sd in FIG. 3, it is possible to suppress the positions of both end portions 51e and 51f of the sipe line 51 in the tire circumferential direction from excessively separating, that is, the overall sipe line 51 from being largely inclined with respect to the tire width direction. As a result, the sipes that constitute the sipe line 51, i.e., the shoulder sipes 23A and 23B, the mediate sipes 22A and 22B, and the center sipe 21, allow a sufficient amount of edge component extending in the tire width direction to be ensured, resulting in a better traction performance on the snowy road surface in particular.

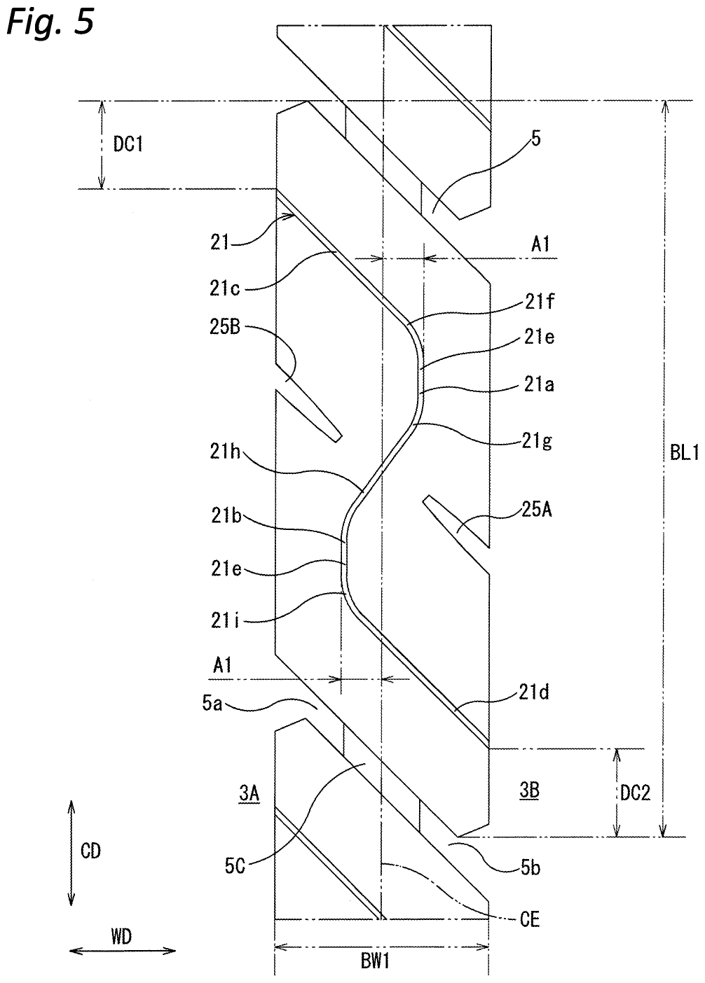

Next, the center block 11 will be further described with reference to FIG. 5.

As described above, one center block 11 is provided with the two mediate blocks 12A and the two shoulder blocks 13A, and has a shape elongated in the tire circumferential direction. Specifically, a length (dimension in the tire circumferential direction) BL1 of the center block 11 is set to be not less than three times and not more than four times a width (dimension in the tire width direction) BW1 of the center block 11.

As described above, the center sipe 21 formed in the center block 11 includes the first widthwise protrusion portion 21a projecting toward the right side (grounding end GEb side) in the figure and the second widthwise protrusion portion 21b projecting in the opposite direction, and the first and second widthwise protrusion portions 21a and 21b are continuously provided in the tire circumferential direction. The center sipe 21 includes a first linear portion 21c having one end connected to the first widthwise protrusion portion 21a and the other end communicating with the center main groove 3A. The first linear portion 21c is inclined with respect to the tire width direction so as to be downward-sloping in the figure. The center sipe 21 includes a second linear portion 21d having one end connected to the second widthwise protrusion portion 21b and the other end communicating with the center main groove 3B. The second linear portion 21d is inclined with respect to the tire width direction so as to be downward-sloping in the figure. The first and second widthwise protrusion portions 21a and 21b have flat portions 21e at their top portions.

The center sipe 21 has four bent portions 21f, 21g, 21h, and 21i, which are bent gently and smoothly. That is, the center sipe 21 does not have a sharply bent portion, that is, a bent portion.

In the figure, a distance DC1 from the upper end of the center block 11 to the end portion of the first linear portion 21c communicating with the center main groove 3A is set in a range of 5% or more and 25% or less of the length BL1 of the center block 11. In the figure, a distance DC2 from the lower end of the enter block 11 to the end portion of the second linear portion 21d communicating with the center main groove 3B is set in a range of 5% or more and 25% or less of the length BL1 of the center block 11. That is, both end portions of the center sipe 21 are positioned in a range of 55% or more and 85% or less of the length BL1 of the center block 11 from both end portions of the center block 11 in the tire circumferential direction.

As described above, the center sipe 21 has an amplitude in the tire width direction that is constituted by the first widthwise protrusion portion 21a and the second widthwise protrusion portion 21b, which project in the directions opposite to each other in the tire width direction. In FIG. 5, a reference symbol A1 indicates an amplitude amount of the center sipe 21. The amplitude amount A1 is a distance in the tire width direction from a center C1 of the center sipe 21 in the tire width direction (which matches the center line of the tread portion 2 in the present embodiment) to the top portions of the first and second widthwise protrusion portions 21a and 21b. The amplitude amount A1 is set to 10% or more and 40% or less of the width BW1 of the center block 11.

The center sipe 21 does not have a bent portion. The both end portions of the center sipe 21 are positioned in the range of 55% or more and 85% or less of the length BL1 of the center block 11 from the both end portions of the center block 11 in the tire circumferential direction, and positioned relatively in proximity to the both end portions of the center block 21 in the tire circumferential direction. The center sipe 21 has a large amplitude, that is, an amplitude of an amount of 60% or more and 85% or less of the width BW1 of the center block. The center sipe 21 has a smooth, large S-shape extending generally over the entire surface of the center block 11. Therefore, the ground contact pressure at the center block 11 is dispersed without being concentrated at one position, and hence the braking performance on the dry road surface can be improved. The two portions of the center block 11 divided by the center sipe 21 support each other at the time of braking, thereby suppressing collapse. As a result, braking performance and uneven wear-resistant performance can be improved.

The center block 11 is provided with notches 25A and 25B extending from both side portions in the tire width direction. The notches 25A and 25B have a tapered shape as viewed in the tire radial direction. The tips of the notches 25A and 25B are positioned between the first widthwise protrusion portion 21a and the second widthwise protrusion portion 21b in the tire circumferential direction. By forming the notches 25A and 25B in addition to the center sipe 21, the distribution of the edge component of the center block 11 is homogenized. That is, uneven distribution of the edge component in the center block 11 can be avoided. As a result, a better traction performance is obtained on the snowy road surface.

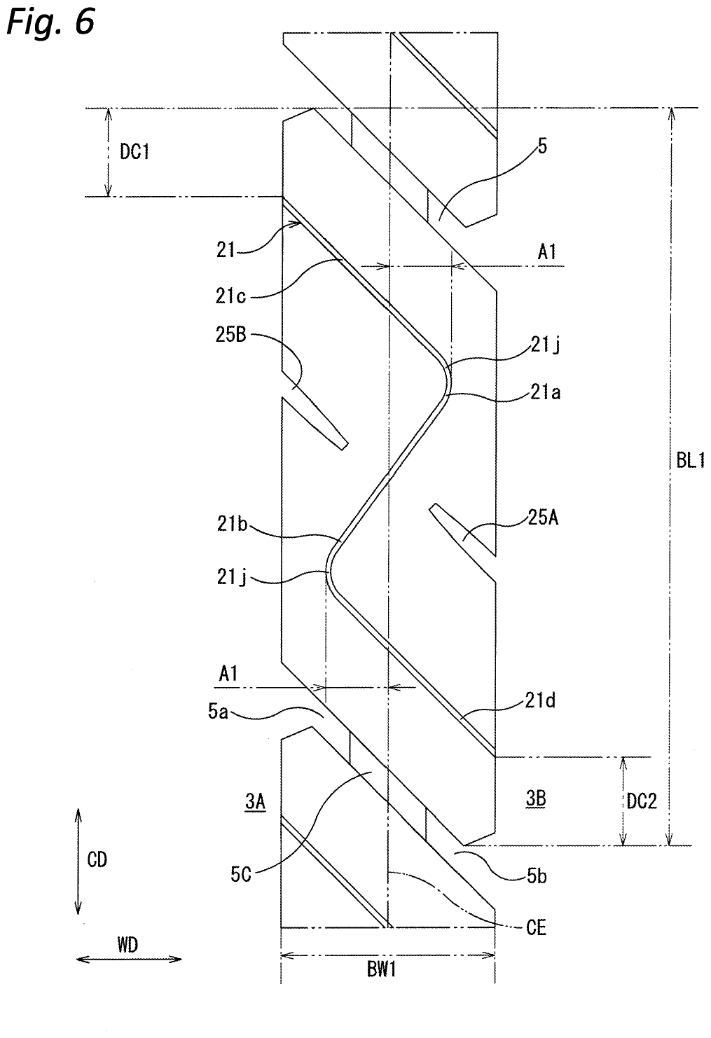

FIG. 6 shows an alternative of the center block 11. In the center block 11, not the flat portion (see the reference symbol 21e in FIG. 5) but the bent portion 21j is provided at the top portions of the first and second widthwise protrusion portions 21a and 21b.

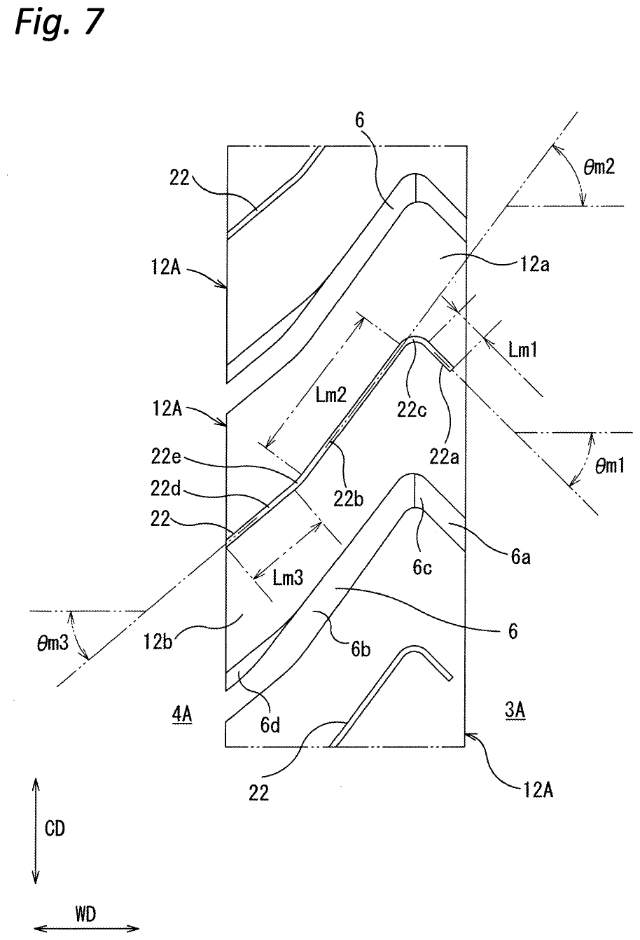

Next, the mediate block 12A will be further described with reference to FIG. 7.

As described above, the mediate sipe 22A formed in the mediate block 12A includes the first portion 22a, which is downward-sloping straight, the second portion 22b, which is upward-sloping straight, and the third portion 22d, which is upward-sloping straight, and has a bent shape overall. According to such a bent shape, it is possible to avoid matching between the mediate sipe 22A with the grounding shape CF (see FIG. 1), and it is possible to reduce impact noise when traveling on the dry road surface in particular.

In order to avoid matching with the grounding shape CF while ensuring that the edge component functions on the snowy road surface, it is preferable to set the mediate sipe 22A as follows. First, an inclination angle θm1 of the first portion 22a with respect to the tire width direction is set to 30 degrees or more and 55 degrees or less. An inclination angle θm2 of the second portion 22b with respect to the tire width direction is set to 40 degrees or more and 65 degrees or less. An inclination angle θm3 of the third portion 22d with respect to the tire width direction is set to 25 degrees or more and 50 degrees or less. Furthermore, a length Lm1 of the first portion 22a is set to 8% or more and 20% or less of the sum of a length Lm2 of the second portion 22b and a length Lm3 of the third portion 22d.

As mentioned above, the end portion of the first portion 22a of the mediate sipe 22A terminates in the mediate block 12A. That is, the mediate sipe 22A is not in communication with the center main groove 3A. Therefore, it is possible to ensure the rigidity of the mediate block 12A, and possible to suppress the collapse of these blocks. As a result, braking performance and wear-resistant performance can be improved.

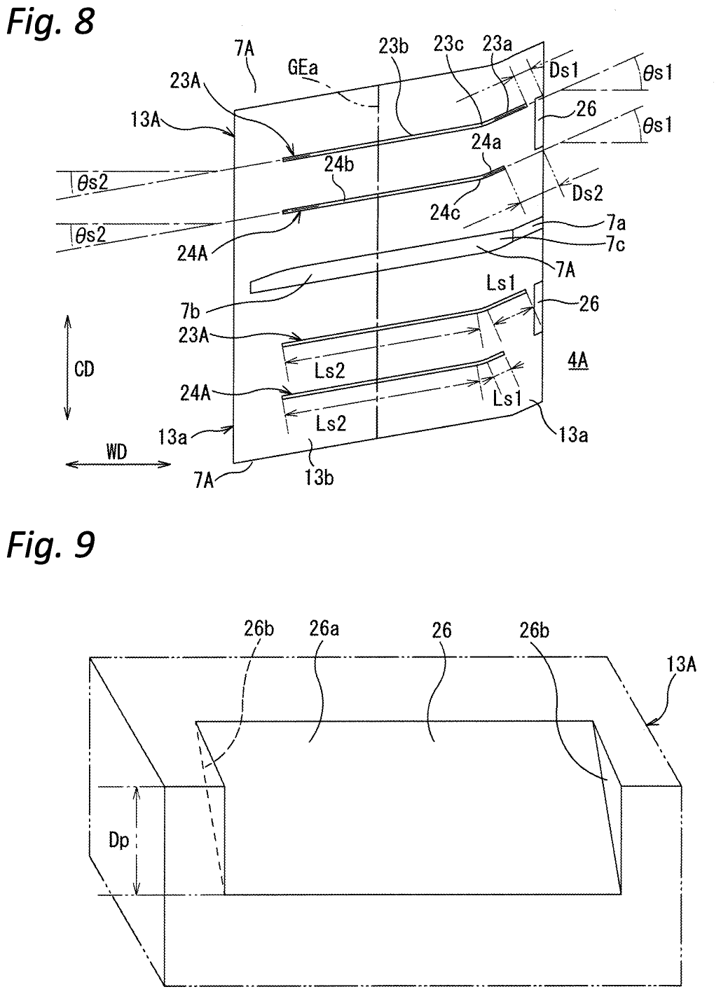

Next, the shoulder block 13A will be further described with reference to FIG. 8.

As described above, the shoulder sipes 23A and 24A are provided in the shoulder block 13A. The end portion of the shoulder sipe 23A on the shoulder main groove 4A side, i.e., the end portion of the first portion 23a terminating in the shoulder block 13A, and the end portion of the shoulder sipe 24A on the shoulder main groove 4A side, i.e., the end portion of the first portion 24a similarly terminating in the shoulder block 13A are different in position of the tire width direction. Specifically, a distance Ds1 between the end portion of the first portion 23a of the shoulder sipe 23A and the shoulder main groove 4A is shorter than a distance Ds2 between the end portion of the first portion 24a of the shoulder sipe 24A and the shoulder main groove 4A. The difference between the distance Ds1 and the distance Ds2 is set in a range of, for example, 2 mm or more and 5 mm or less.

Providing the shoulder sipes 23A and 24A on the shoulder block 13A improves the traction performance on the snowy road surface and ensures the traveling performance on the snowy road surface. Since the end portion of the first portion 23a of the shoulder sipe 23A and the end portion of the first portion 24a of the shoulder sipe 24A are different in position of the tire width direction, it is possible to avoid the ground contact pressure in the shoulder block 13A from concentrating in one position in the tire width direction, that is, in one straight line extending in the tire circumferential direction. As a result, braking performance on the dry road surface can be improved. Furthermore, the first portion 23a of the shoulder sipe 23A and the first portion 24a of the shoulder sipe 24A terminate in the shoulder block 13A. That is, each of the shoulder sipes 23A and 24A is not in communication with the shoulder main groove 4A. Therefore, the rigidity of the shoulder block 13A can be ensured, and the wear-resistant performance can be improved.

The first portion 23a and the second portion 23b of the shoulder sipe 23A are different in angle formed with respect to the tire width direction. Similarly, the first portion 24a and the second portion 24b of the shoulder sipe 24A are different in angle formed with respect to the tire width direction. By having the first portions 23a and 24a and the second portions 23b and 24b that extend at different angles, it is possible to avoid matching between the shoulder sipes 23A and 24A with the grounding shape CF (see FIG. 1), and it is possible to reduce impact noise when traveling on the dry road surface in particular. That is, such the constitution can improve noise performance.

In order to avoid matching with the grounding shape CF while ensuring that the edge component functions on the snowy road surface, it is preferable to set the shoulder sipes 23A and 24A as follows. First, an inclination angle θs1 of the first portions 23a and 24a with respect to the tire width direction is set to 10 degrees or more and 40 degrees or less. An inclination angle θs2 of the second portions 23b and 24b with respect to the tire width direction is set to 25 degrees or more and 50 degrees or less. Furthermore, a length Ls1 of the first portions 23a and 24a is set to 25% or more and 50% or less of a length Ls2 of the second portions 23b and 24b.

The shoulder block 13A is provided with a recess portion 26 in a portion facing the shoulder main groove 4A, i.e., a portion where the top wall and the side wall of the shoulder block 13A merge. A depth Dp of the recess portion 26 is set to, for example, 10 mm or more and 3 mm or less. With reference also to FIG. 9, the recess portion 26 of the present embodiment is constituted of a tapered surface 26a and a pair of side surfaces 26b opposed in the tire circumferential direction. Providing the recess portion 26 can further improve the traction performance on the snowy road surface.

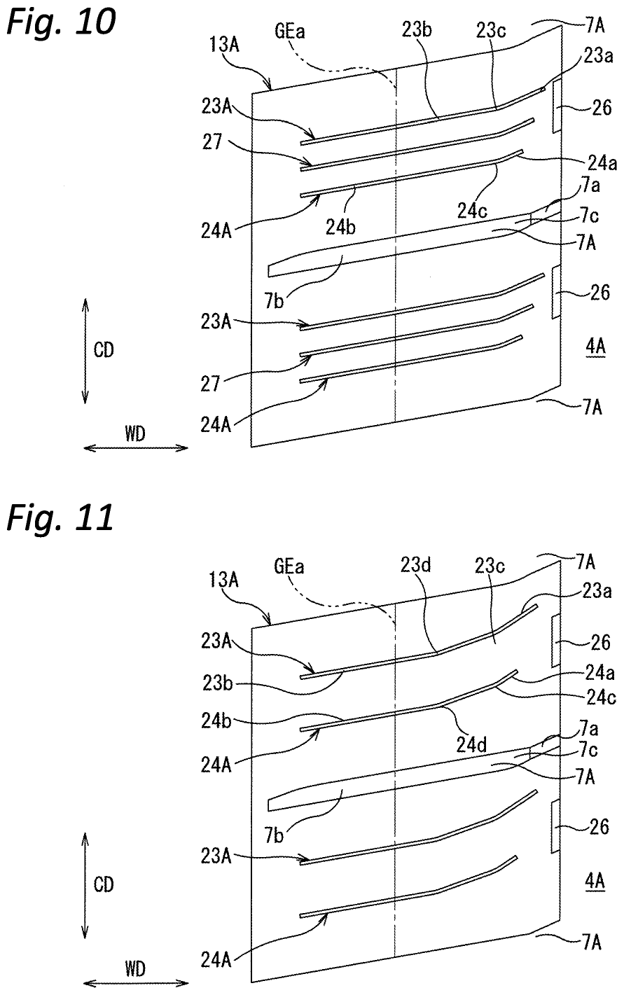

An alternative shoulder block 13A shown in FIG. 10 is provided with an additional shoulder sipe 27 of a similar shape between the shoulder sipes 23A and 24A.

In another alternative shoulder block 13A shown in FIG. 11, the first portions 23a and 24a of the shoulder sipes 23A and 24A have bent portions 23d and 24d.

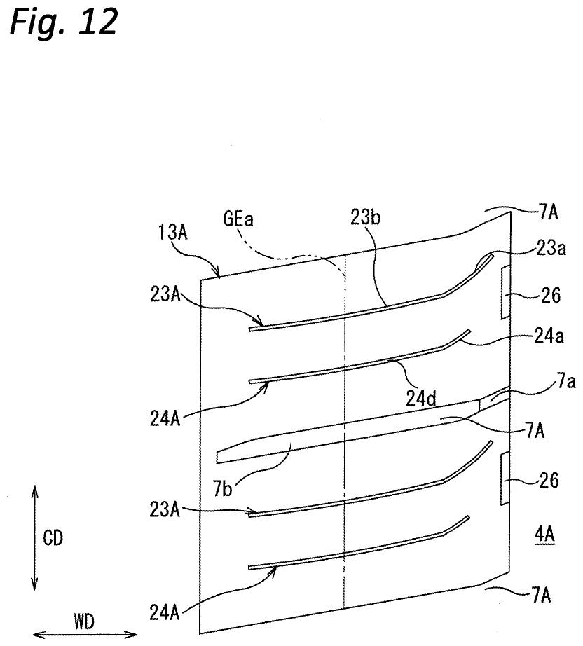

In yet another alternative shoulder block 13A shown in FIG. 12, the first portions 23a and 24a and the second portions 23b and 24b of the shoulder sipes 23A and 24A are arc-shaped.

What is claimed is:

1. A pneumatic tire comprising:
a plurality of main grooves formed in a tread portion so as to extend in a tire circumferential direction;
a plurality of land portions defined by at least the main grooves; and
a plurality of sipes respectively formed on the land portions, wherein a sipe line that is a line constituted of continuation of the sipe extends from one grounding end toward the other grounding end of the tread portion and has an amplitude in both a tire circumferential direction and a tire width direction.

2. The pneumatic tire according to claim 1, wherein the sipe line includes
a first circumferential protrusion portion that projects in one direction of the tire circumferential direction,
a second circumferential protrusion portion that projects in a direction opposite to the direction of the tire circumferential direction,
a first widthwise protrusion portion that projects in one direction of the tire width direction, and
a second widthwise protrusion portion that projects in a direction opposite to the direction of the tire width direction.

3. The pneumatic tire according to claim 2, wherein the first widthwise protrusion portion and the second widthwise protrusion portion are positioned between the first circumferential protrusion portion and the second circumferential protrusion portion.

4. The pneumatic tire according to claim 2, further comprising:
a plurality of lateral grooves formed on the tread portion so as to extend in a direction intersecting with the tire circumferential direction, wherein
the main groove includes a pair of center main grooves arranged adjacent to each other across a center line of the tread portion in a tire width direction, and
both the first widthwise protrusion portion and the second widthwise protrusion portion of the sipe line are constituted by one center sipe formed in a center block defined by the center main grooves and the lateral grooves.

5. The pneumatic tire according to claim 3, further comprising:
a plurality of lateral grooves formed on the tread portion so as to extend in a direction intersecting with the tire circumferential direction, wherein
the main groove includes a pair of center main grooves arranged adjacent to each other across a center line of the tread portion in a tire width direction, and
both the first widthwise protrusion portion and the second widthwise protrusion portion of the sipe line are constituted by one center sipe formed in a center block defined by the center main grooves and the lateral grooves.

6. The pneumatic tire according to claim 4, wherein
the main groove includes a pair of shoulder main grooves respectively arranged adjacent to an outer side of the tire width direction with respect to the center main groove,
the first circumferential protrusion portion includes a first mediate sipe formed in a first mediate block defined by one of the center main grooves, one of the shoulder main grooves that is positioned on the outer side of the tire width direction with respect to the one of the center main grooves, and the lateral grooves, and
a second circumferential protrusion portion include a first mediate sipe formed in a second mediate block defined by the other of the center main grooves, one of the shoulder main grooves that is positioned on the outer side of the tire width direction with respect to the other of the center main grooves, and the lateral grooves.

7. The pneumatic tire according to claim 5, wherein
the main groove includes a pair of shoulder main grooves respectively arranged adjacent to an outer side of the tire width direction with respect to the center main groove,
the first circumferential protrusion portion includes a first mediate sipe formed in a first mediate block defined by one of the center main grooves, one of the shoulder main grooves that is positioned on the outer side of the tire width direction with respect to the one of the center main grooves, and the lateral grooves, and
a second circumferential protrusion portion includes a first mediate sipe formed in a second mediate block defined by the other of the center main grooves, one of the shoulder main grooves that is positioned on the outer side of the tire width direction with respect to the other of the center main grooves, and the lateral grooves.

8. The pneumatic tire according to claim 6, wherein
an end portion on the one center main groove side of the first mediate sipe terminates in the first mediate block, and
an end portion on the other center main groove side of the second mediate sipe terminates in the second mediate block.

9. The pneumatic tire according to claim 7, wherein
an end portion on the one center main groove side of the first mediate sipe terminates in the first mediate block, and
an end portion on the other center main groove side of the second mediate sipe terminates in the second mediate block.
